(19) United States
(12) Patent Application Publication
(10) Pub. No.: US 2007/0029276 A1
(43) Pub. Date: Feb. 8, 2007

(54) Drinking vessel

(76) Inventor: Claire Clare, Glos (GB)

Correspondence Address: KING & SCHICKLI, PLLC, 247 NORTH BROADWAY, LEXINGTON, KY, 40507, US

(21) Appl. No.: 10/557,101

(22) PCT Filed: May 14, 2004
(86) PCT No.: PCT/GB04/02076

§ 371 Date: Nov. 16, 2005

Related U.S. Application Data
(60) Provisional application No. 60/489,511, filed on Jul. 24, 2003.

(30) Foreign Application Priority Data
May 17, 2003 (GB) 0311377.6

(51) Int. Cl. B65D 23/12; A47J 41/00

(52) U.S. Cl. 215/395; 220/592.17

(57) ABSTRACT

This invention relates to drinking vessels and in particular a cup, generally indicated at (10), comprising an inner liquid reservoir (11) and an outer splayed wall (12). The angle X between the reservoir (11) and the wall (12) is about 3°. The splayed out wall defines an enlarged based foot print, which both makes the cup stable and contributes to the ability of the cup to restore itself to a vertical position from a significantly titled position.

This invention relates to drinking vessels.

So called “no spill” drinking cups for toddlers, and indeed the very elderly, have been subject to extensive research and many patents. This type of cup has a lid and a drinking spout and some sort of valving arrangement to prevent liquid coming out of the spout when the cup is inverted or knocked over. As children's dexterity increases, they then tend to progress to an ordinary drinking cup or glass and for the most part these are only distinguished by the make of plastics and varying suitable motifs. The elderly also prefer to be able to use an ordinary drinking vessel for as long as possible. Both the young and the elderly often have a problem putting the drinking vessel back down onto a table with the base parallel to the table top. Instead the edge frequently is the first part of the vessel to touch and if the vessel is released at that point, it will usually fall over and spill its contents.

It has been proposed to provide a cup with a weighted base so that the mass in the base tends to pull the vessel back into a vertical position in the manner of the children's weighted toy clown. However, if such cups are to prevent spilling on the first inclination of the cup, the restoring action has to be rapid and this means that the restoring force is often large causing over compensation, which leads to the liquid sloping violently in the vessel and can lead to spillages in that way. Further the action is likely to encourage young children to deliberately tip the vessel.

From a first aspect the present invention consists in a drinking vessel having an outer wall and an inner liquid reservoir with an open mouth, wherein the outer wall splays outwardly from the mouth to form a base footprint of greater area than the mouth the arrangement being such that a vertical line extending downwardly from the centre of gravity of the vessel lies within the base footprint when the vessel is inclined with the plane of the base footprint at angles of up to about 50 degrees to the horizontal.

It has been found that by having a base footprint of greater area than the mouth and the centre of gravity arranged as defined above, the vessel not only restores itself to its stable position when misplaced at an angle, on its edge, on a table, there is also limited rebound, so that spills are significantly reduced.

Preferably the bottom of the reservoir is flush with the lower edge of the outer wall. This not only maximises the volume that the vessel can contain and increases stability by ensuring that the weight of the liquid adds to the mass adjacent the base footprint, it also increases the sliding friction between the vessel and the surface on which it sits, decreasing the number of accidents that will happen due to the vessel receiving a horizontal force, for example from a flaying arm. The bottom may be patterned to increase the friction.

The reservoir may narrow towards its bottom and, in one arrangement the reservoir and the wall may be constituted by oppositely sensed frusto-cones. The opposite tapering is beneficial, because it enables moulding in a single tool. In a preferred embodiment the vessel is formed as a single integral moulding. The angle between the outer wall and the reservoir may be between 2 and 5 degrees.

The ratio of the area of the mouth to the area of the base may be at least about 3:4.

The vessel may be a cup and may have a handle.

Although angles of up to 50 degrees can conveniently be reached for the angle between the vertical line and the horizontal when the vertical line passes through the base footprint it will be understood that greater angles could be achieved by increasing the area of the base footprint. Equally, for aesthetic reasons, smaller angles may be angles and angles of up to 40 or 45 degrees may provide suitable upper inclinations for certain markets.

From another aspect the invention consists in the drinking vessel having a mouth and the base where the ratio of the area of the mouth to the base is at least about 3:4 and the vessel has an outer divergent wall and an inner liquid reservoir.

Although the invention has been defined above it is to be understood it includes any inventive combination of the features set out above or in the following description.

The invention may be performed in various ways and specific embodiments will now be described, by way of example, with reference to the accompanying drawings, in which:

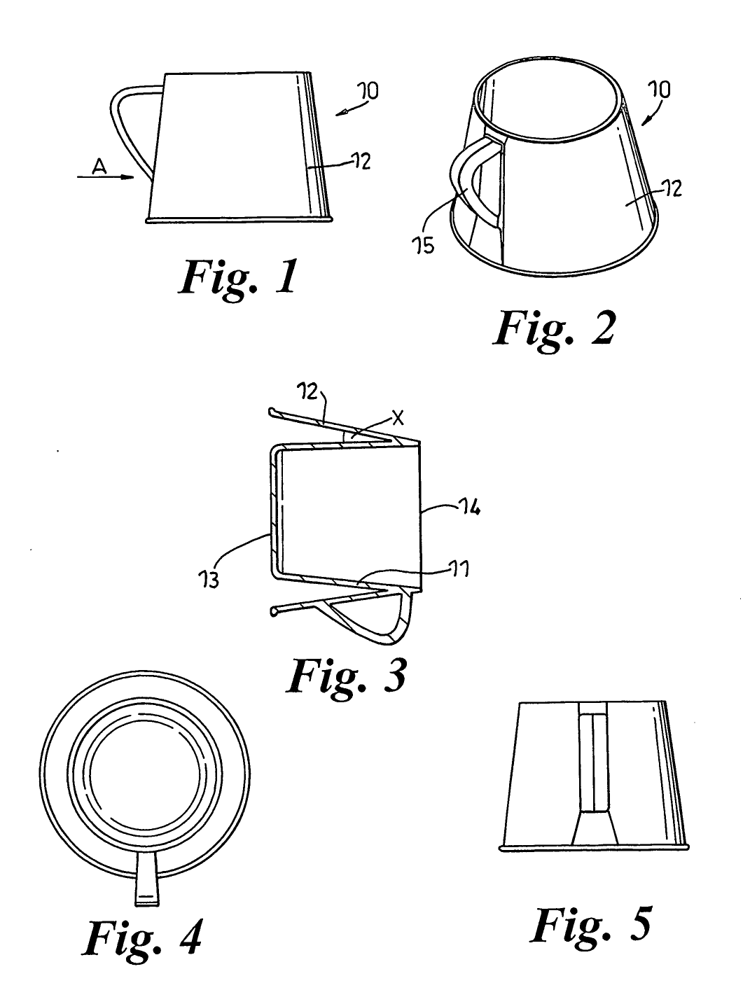

FIGS. 1 to 5 are respectfully a side view, an isometric view, a vertical sectional view turned through 90 degrees, a plan view and a view on the arrow A taken on FIG. 1.

A cup, generally indicated at 10, comprises an inner liquid reservoir 11 and an outer splayed wall 12. The inner reservoir 11 tapers towards its bottom 13 from a mouth 14 a handle 15 is provided, but the design is equally applicable to handleless drinking vessels. The angle x between the reservoir 11 and wall 12 is about 3 degrees.

It will be understood that the splayed outer wall 12 defines an enlarged base footprint, which not only makes the cup 10 extremely stable against blows to its side wall or handle when it is sitting on a table, it also contributes significantly to the ability of the cup to restore itself to a vertical position from a significantly tilted position. This is because the use of the double wall arrangement in which the reservoir 11 extends downwardly so that the bottom 13 is substantially level with the free edge of the wall 12, means that the centre of gravity of the cup is highly centralised and low within the cup so that a vertical line extending downwardly from the centre of gravity will pass through the base footprint even when the plane of the base footprint is at angles of up about 50 degrees to the horizontal. This means that the cup will restore itself in most situations where the user misplaces it on the table, although it will not prevent deliberate spillage.

In the current embodiment the ratio of the area of the mouth to the area of the base footprint is about 3:4. If the base footprint is increased, the stability will increase, but aesthetically it is believed that this proportion is about the best compromise between looks and functionality.

1. A drinking vessel having an outer wall and an inner liquid reservoir with an open mouth wherein the outer wall splays outwardly from the mouth to form a base footprint of greater area than the mouth, the arrangement being such that a vertical line extending downwardly from the centre of gravity of the vessel lies within the base footprint when the vessel is inclined with the plane of the base footprint at angles of up to about 50° to the horizontal.

2. A vessel as claimed in claim 1 wherein the bottom of the reservoir is flush with the lower edge of the outer wall.

3. A vessel as claim in claim 1 wherein the reservoir narrow towards its bottom.

4. A vessel as claimed in claim 1 wherein the walls of the reservoir are constituted by oppositely sensed frusto-cones.

5. A vessel as claimed in claim 1 wherein there is an angle of 2° and 5° between the outer wall and the reservoir.

6. A vessel as claimed in claim 1 formed as a single integral moulding.

7. A vessel as claimed in claim 1 wherein the vessel is a cup with a handle.

8. A vessel as claimed in claim 1 wherein ratio to the area of the mouth to the area of the base is at least about 3:4.

9. A vessel as claimed in claim 1 wherein the vertical line passes through the base footprint at angles of inclination up to 40° or 45°.

10. A drinking vessel having a mouth and an base wherein the ratio of the area of the mouth to the base is at least about 3:4 and the vessel has an outer divergent wall and an inner liquid reservoir.
